(19) United States
(12) Patent Application Publication
(10) Pub. No.: US 2002/0123913 A1
(43) Pub. Date: Sep. 5, 2002

(54) LAYOVER MANAGEMENT SYSTEM FOR CREW LODGING

(76) Inventors: JOHN BUTTERLY, SCOTTSDALE, AZ (US); FRANK DOMBROWSKI, SCOTTSDALE, AZ (US); JOHN LOCKHART, CAVE CREEK, AZ (US)

Correspondence Address: SANDRA L. ETHERTON, FENNEMORE CRAIG, 3003 N. CENTRAL AVENUE, SUITE 2600, PHOENIX, AZ, 850122913

(21) Appl. No.: 09/256,720

(22) Filed: Feb. 24, 1999

(51) Int. Cl. G06F 17/60

(52) U.S. Cl. 705/6

(57) ABSTRACT

A centralized system accurately forecasts the number of rooms required at a given hotel for airline crew members for a given day, makes reservations, updates the hotels on necessary changes only, and publishes accurate billing statements for rooms used. The system operates internally on a room inventory model which provides both accurate changes on a continuing basis and a buffer to reduce the number of reservation changes requested of the hotel. The process utilizes two main subsystems. The first subsystem is responsible for replication and storage of each airline's flight schedule data and also for applying a basic set of established airline business rules to determine general layover requirements. The second subsystem receives these layover requirement requests, applies additional airline and hotel business rules to determine a more detailed set of layover requirements, manages the hotel room procurement, addresses real-time flight changes as they affect hotel room usage, and finally produces period-end reporting.

### BACKGROUND OF INVENTION

This invention relates generally to business management systems. More specifically, this invention relates to a method for performing data processing operations to manage changing crew member lodging involving stays of varying duration.

Airline travel from city to city causes flight attendants and pilots to stay in hotels, sometimes overnight, sometimes for only part of a day. Each such extended stop on a trip is known as a layover. For each layover a reservation must be made in advance at a hotel and transportation to and from the hotel must be arranged for each crew member. Because the crew members may be arriving from or departing to different destinations, each crew member's length of stay may be different from the other crew members. The scheduling is complicated further by schedule changes due to weather, airplane problems, and capacity issues. Airlines often make schedule changes weeks in advance, or hours in advance, and may make subsequent changes which reverse the prior changes.

Over the years, agreements have been made that dictate which hotels can be used for pilots, which hotels for flight attendants, which hotels for longer or shorter layovers, the cost of each room, how many crew members can stay in one room, etc. Tax laws dictate the amount of tax paid on each room, which may be affected by the number of rooms used continually per month.

Historically, the organization and coordination of these various inputs have been done manually. Each airline sends its schedule to each approved hotel. The hotel then manually deciphers and examines the airline schedule to calculate each layover and the number of rooms necessary to handle the size of each arriving crew. When the airline changes its schedule, it might notify the hotel of the change. The hotel could then recalculate the layovers and number of rooms required. In fact, however, few changes by the airlines of flight schedules, crew members'identity, and other factors are communicated to the hotel after the original schedule is sent, regardless of the effect on the hotel's reservations. Sometimes when changes are made close to the arrival time of the crew members, the hotel is not notified of the change until the crew member arrives at the hotel, leaving the hotel with insufficient time to make an appropriate reservation adjustment. Under prior art systems, a hotel receives notice that a different crew member will be arriving than previously listed. Even though the number of rooms reserved stays the same, the hotel does not know this until it processes the change. The hotel verifies that a room had been reserved under the initial crew member's flight number, change the reservation to reflect the new crew member, but not adjust the rooms reserved, thereby taking unnecessary time and effort to process a change that had no effect on the hotel's room capacity. This practice makes it difficult for hotels to have the correct number of rooms available and for airlines to track and pay for the rooms they actually use, resulting in inefficiencies for the hotel and additional expense for the airlines. It is desirable to provide a computerized system for managing crew member layovers which provides accurate hotel reservation requirements in a timely manner and limits the number of changes a hotel must make to its reservations.

### BRIEF SUMMARY OF THE INVENTION

This invention automates layover management to improve efficiency and lower costs to the airline. For each airline a centralized system accurately forecasts the number of rooms required at a given hotel for airline crew members for a given day, makes reservations, updates the hotels on necessary changes only, and publishes accurate billing statements for rooms used. The system operates internally on a room inventory model which provides both accurate changes on a continuing basis and a buffer to reduce the number of reservation changes requested of the hotel.

The process utilizes two main subsystems. The first subsystem is responsible for replication and storage of each airline's flight schedule data and also for applying a basic set of established airline business rules to determine general layover requirements. The second subsystem receives these layover requirement requests, applies additional airline and hotel business rules to determine a more detailed set of layover requirements, manages the hotel room procurement, addresses real-time flight changes as they affect hotel room usage, and finally produces period-end reporting.

### BRIEF DESCRIPTION OF THE DRAWINGS

FIG. 1 is flowchart showing an overview of the method of the present invention.

FIG. 2 is a flowchart showing an overview of the two primary subsystems of the present invention, the airline information system and the layover management system.

FIG. 3 is a flowchart showing a detailed view of the airline information system.

FIG. 4 is a flowchart showing a detailed view of the forecast segment of the layover management system.

FIG. 5 is a flowchart showing a detailed view of the process updates segment of the layover management system.

FIG. 6 is a flowchart showing a detailed view of the hotel communication and change notification segment of the layover management system.

FIG. 7 is a flowchart showing a detailed view of the inventory creation segment of the layover management system.

FIG. 8 is a flowchart showing a detailed view of the procurement segment of the layover management system.

FIG. 9 is a flowchart showing a detailed view of the reporting segment of the layover management system.

### DETAILED DESCRIPTION OF THE PREFERRED EMBODIMENTS

### Overview

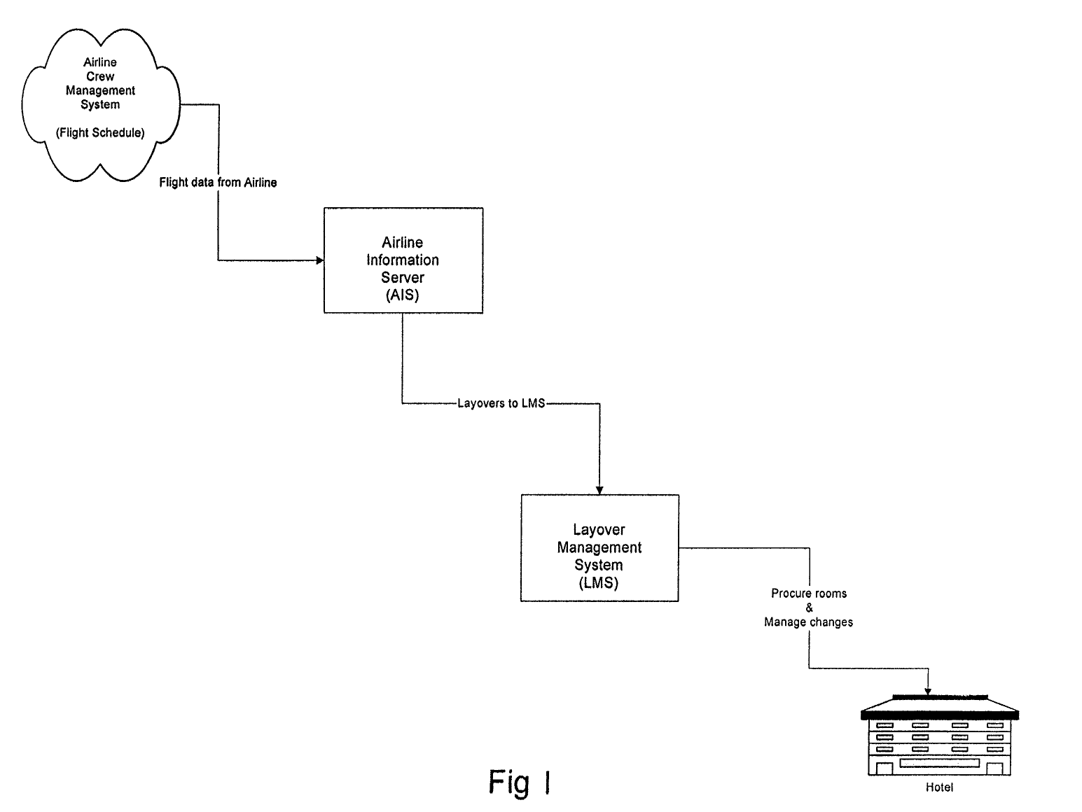

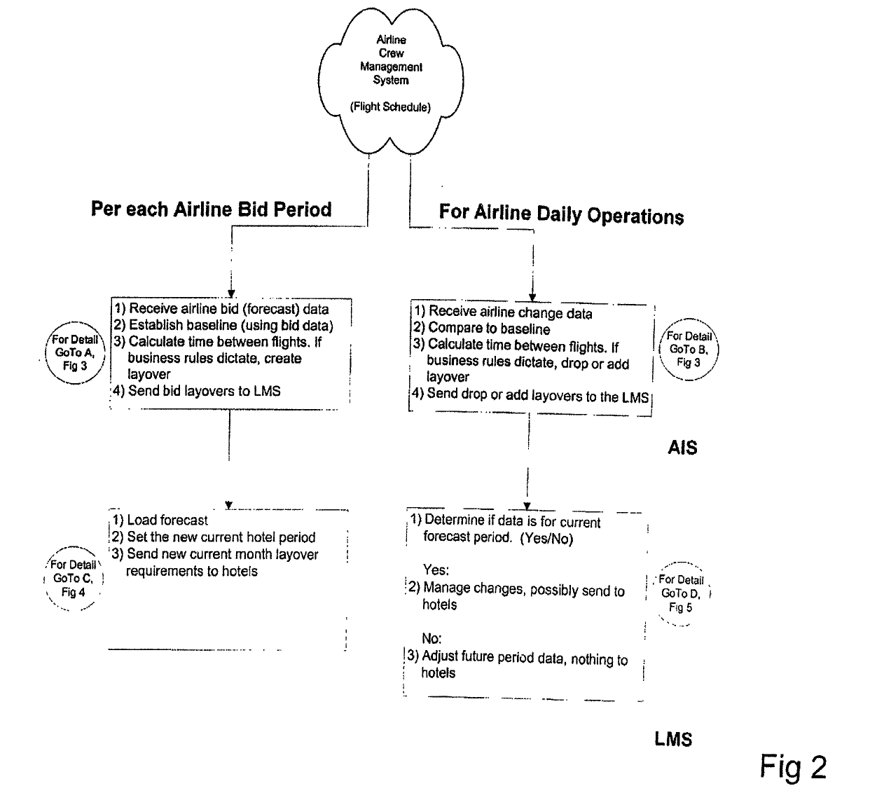

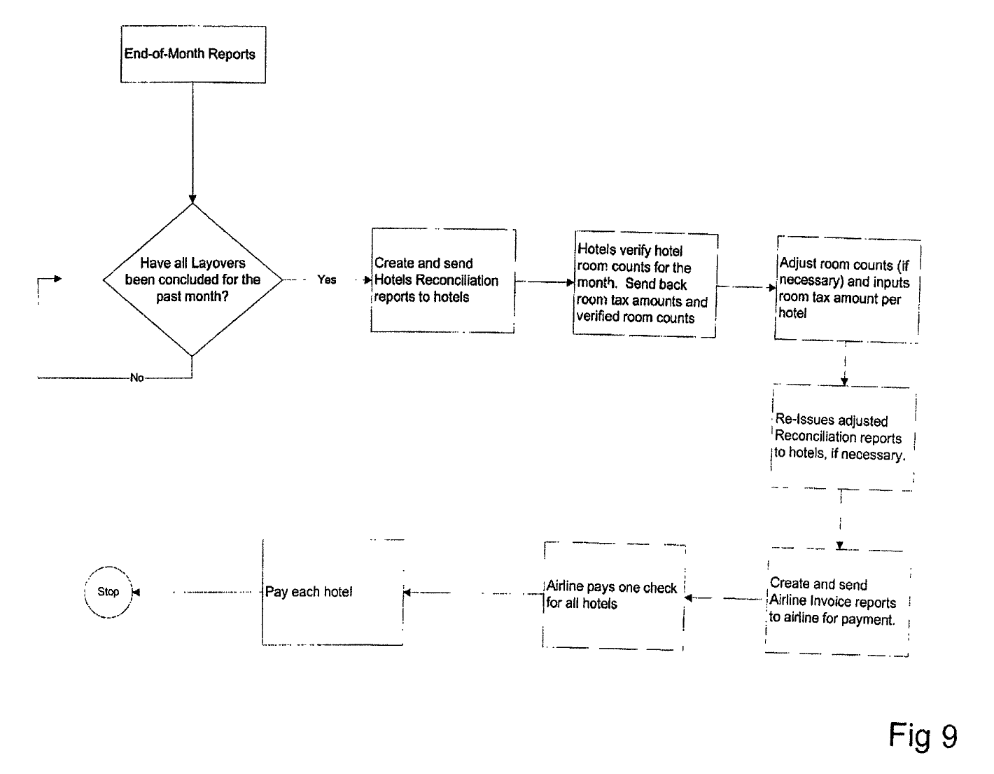

The present invention is best understood by referring to FIGS. 1-9 which show the process flow for the invention. The process is implemented in software over a computer network and utilizes two main subsystems. See FIGS. 1 and 2. In overview, flight schedule information is received from each airline and passed to the first subsystem, the Airline Information System (MIS). After processing the data with basic airline business rules to determine general layover requirements, the layovers are passed to the second subsystem, the Layover Management System (LMS). The LMS processes the layover data following hotel business rules and additional airline rules to determine more detailed layover requirements, manages hotel room procurement, addresses real-time flight changes as they affect hotel room usage, and provides periodic reporting to each hotel and airline.

To properly process the airline data, each of these subsystems requires that predetermined rules be considered and applied to meet the needs of each airline. Specific airline and hotel rules are set-up in static data tables for each airline customer. These rules govern each phase of the application processing in the AIS and LMS. The rule sets include items such as specific airline union rules, layover duty break minimums, crew type requirements, layover city rules, airline-hotel contracted pricing, hotel reservation parameters such as check-in and departure times, hotel contact method such as automated interface, phone, fax, or email, hotel type, communication timing, and report types.

Throughout this description the word “reservation” refers to the request made to the hotel for a given number of crew member beds. Once reservations are confirmed by the hotel, the number of beds requested becomes “inventory.” The word “inventory” refers to the number of beds available for crew members. Beds available for non-crew members, such as members of the general public, are not a part of inventory as used herein. The present system limits the number of changes in inventory by managing as many changes as possible within the system in a manner invisible to the hotel.

### AIS

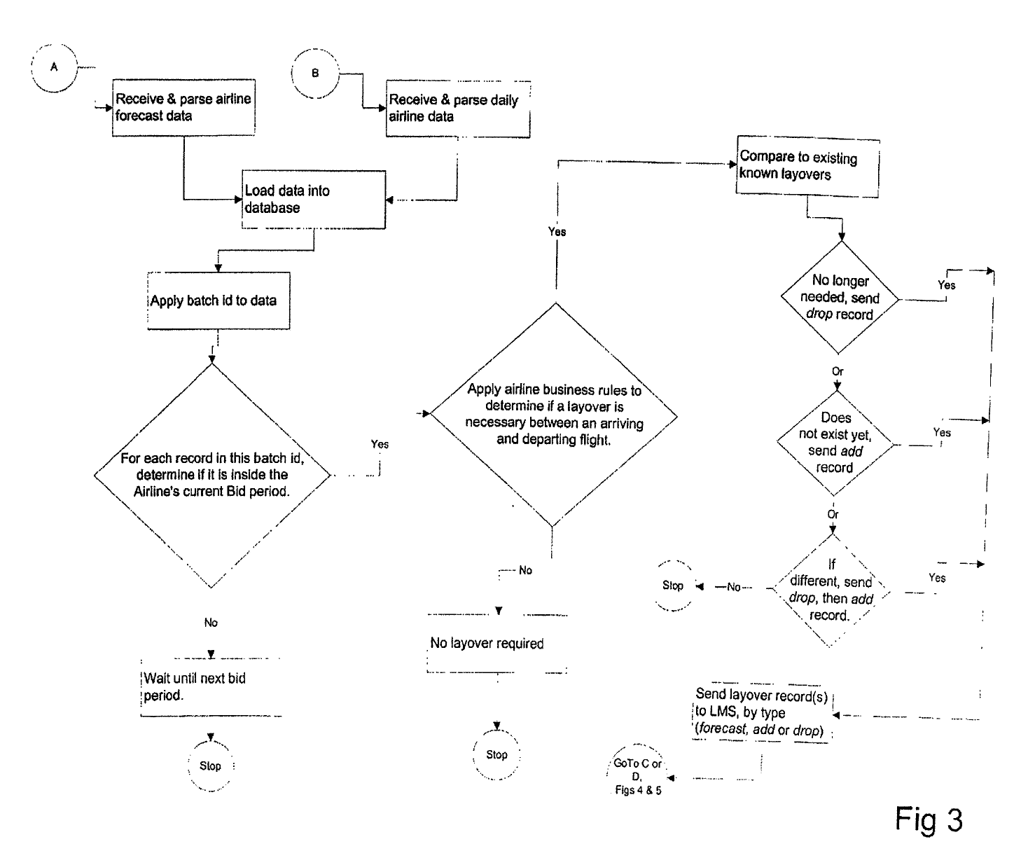

FIG. 3 illustrates the AIS process in more detail. The AIS periodically receives airline flight information in electronic form from each airline. The batches of data vary in size, but a forecast batch typically contains approximately two months of flight information. Smaller batches supplement the main batches at irregular intervals. Each batch of data is parsed into records and loaded into a database. A batch ID is given to each batch of records.

The airline forecast period is a predetermined time period known as the Bid Period. A baseline flight schedule is established from the records within the Bid Period. The records include the time and date of each flight and the number of pilots and other crew members traveling on each flight. The time between an arriving and a departing flight is calculated and, if airline rules dictate, a layover at a given station (airport locale) is forecasted. A layover is required for a crew member stopping at a given destination for a given period of time that is determined by the airline business rules. Whether a layover is required depends on multiple factors such as whether the crew member is a pilot or a flight attendant, whether the flight is international or domestic, time on the ground and the station. If the time between the crew member's arriving and departing flight is less than the time specified in the airline rules, no layover is required. At this point the layover requirement specifies only whether a room is needed and the duration of the layover. The specifics of that room, such as the hotel where it will be reserved, are not yet determined.

The Bid Period establishes the baseline for all subsequent change activity. The forecasted layovers for a given Bid Period are sent to the LMS as forecast data. Each subsequent batch of data received by the AIS is processed in a manner similar to the forecast batch. The AIS stores flight schedule data and layovers as calculated by the AIS.

Once the layover requirements have been determined and the forecast data sent to the LMS, any new layover requirements are compared to the existing layovers previously stored in the AIS. If changes are necessary based on the new data, the AIS sends the LMS a record of the change by type of change required in the form of deletions. additions or updates. If a corresponding layover previously existed for a given batch of data in a given Bid Period but is no longer needed, a deletion is required and the AIS sends the LMS a DROP record, which is described in more detail below. If a corresponding layover does not yet exist but needs to be added, an addition is required and the AIS sends the LMS an ADD record, described below. If a corresponding layover already exists in the AIS but has different flight details in a given Bid Period, an update is required and the AIS sends the LMS a DROP record to rid it of the old, incorrect data and then the AIS sends an ADD record to update the LMS with the new, accurate data.

### LMS

The LMS automated crew lodging process is based on the room management inventory model. The LMS has room inventory that is analogous to the hotel industry's fixed commodity—beds. A reservation made by the LMS is for a given number of rooms. Under current union contracts there is only one bed counted per room, each crew member must have her or her own room, and rooms are never shared. Rooms are the common denominator for all reservations, which enables the LMS to withhold changes that do not affect the number of rooms required. For example, if a different crew member will be arriving than previously expected, that new crew member will still require a room. Under the present invention, the hotel would not be notified of that change in the crew member's identity because the change does not affect the number of rooms to be held for crew members, unless the change was for the same day, as discussed below.

The hotel receives a forecast of layovers in the form of a group of reservation requests from the LMS in advance of when the rooms are needed. The hotel will confirm or decline the reservations. Confirmed reservations become inventory available for the airline to use for crew members. The LMS prepares a daily crew report for the hotel which includes crew member identity and flight numbers. Because each crew member has specific abilities such as being licensed to fly a certain type of plane, each crew member must be identifiable at a personal level in the hotel. Only in the event of sameday changes is the hotel notified of changes to that daily crew report.

A subset of the Bid Period is the Current Hotel Period, typically the current month. The LMS receives the layover data as calculated in the AIS and evaluates each record passed to it from the AIS to determine whether the record falls within the Current Hotel Period. The layover data received beyond the Current Hotel Period is held and not processed until it becomes the Current Hotel Period data. Prior to each new Current Hotel Period the data is marked as “current” and a month-at-a-glance (MAAG) report is published for each hotel. The report is preferably published to the hotels ten days before the new month, which is the lead time used throughout the description herein, although other time frames may be used.

Filtering the data by time period allows processing of current data only, while allowing future data to be held in abeyance until it appropriate to process the data. This minimizes the amount of extraneous calculations during layover management, thereby increasing the efficiency of the system and limiting the number of changes each hotel receives. Changes are made to the flight schedule constantly, resulting in numerous varieties of potential ADDS, DROPS, and updates. Typical scenarios which occur daily include the following examples.

TABLE 1
Create Inventory Then Add New Flights
Using Existing Inventory Rooms

| Events | 1^{st} day | 2^{nd} day | 3^{rd} day | 4^{th} day | Comment |
|---|---|---|---|---|---|
| Forecast | Create 1 | Create 1 | Create 1 | Create 1 | None |
| Flight 001 for | room of | room of | room of | room of | |
| Phoenix. | inventory | inventory | inventory | inventory | |
| Arrival and | for crew | for crew | for crew | for crew | |
| departure | member | member | member | member | |
| creates 4 days | Bob | Bob | Bob | Bob | |
| of layover | | | | | |
| Cancel Flight | Bob will | Bob will | Bob will | Bob will | Creates |
| 001 | not be | not be | not be | not be | inventory caused |
| | arriving, | arriving, | arriving, | arriving, | by the cancelled |
| | make the | make the | make the | make the | flight. |
| | inventory | inventory | inventory | inventory | |
| | room | room | room | room | |
| | empty | empty | empty | | |
| New flight: | Put Tom | Put Tom | Put Tom | Empty | *Used 3 of 4 |
| 123 to | in the | in the | in the | inventory | inventory rooms |
| Phoenix. | empty | empty | empty | room is | |
| Arrival and | inventory | inventory | inventory | still | |
| departure | room that | room that | room that | available | |
| creates 3 days | was | was | was | | |
| of layover, | originally | originally | originally | | |
| | made for | made for | made for | | |
| | Bob. | Bob. | Bob. | | |
| New flight: | | | | Put Joe | *Used last |
| 456 to | | | | in the | inventory room |
| Phoenix. | | | | empty | |
| Arrival and | | | | inventory | |
| departure | | | | room that | |
| creates 1 day | | | | was | |
| of layover. | | | | originally | |
| | | | | made for | |
| | | | | Bob | |

Crew swaps, as marked by an asterisk in Table 1 above, do not necessarily result in a communication to the hotels because the change does not affect the number of rooms in inventory. The change in crew member name may be reported on the day the specific crew member will arrive.

TABLE 2
Change Flight Details

| Events | 1^{st} day | 2^{nd} day | 3^{rd} day | 4^{th} day | Action |
|---|---|---|---|---|---|
| Forecast | Bob | Bob | Bob | Bob | None |
| Change flight | Create | Create | Create | Create | Creates |
| detail: | inventory | inventory | inventory | inventory | inventory rooms |
| original flight | room | room | room | room | caused by |
| is dropped. | | | | | dropped flight. |
| Change flight | Assign | Assign | Assign | Still | Uses inventory |
| detail: new | new | new | new | available | rooms, then |
| flight time is | details to | details to | details to | | determine if |
| shortened 1 | inventory | inventory | inventory | | notice should be |
| day so | room | room | room | | communicated |
| layover is | | | | | to hotel. |
| shortened | | | | | |

The LMS receives all layover data from the AIS, but acts only on data within the Current Hotel Period. Data that is sent to the LMS outside the Current Hotel Period is held but not processed until such time as the data falls into the Current Hotel Period. The following activities are under the management of the LMS: layovers are assigned and unassigned to given rooms, flight numbers and flight times are changed, flights are cancelled and new flights are added. Instead of reacting to each and every schedule change, the LMS applies rules to ascertain if and when a change impacts an existing crew room requirement and whether a communication should be provided to a hotel regarding a room add, change, or cancellation. The LMS is broken down into six processes: forecast, process updates, hotel communication and change notification, inventory creation, procurement and reporting.

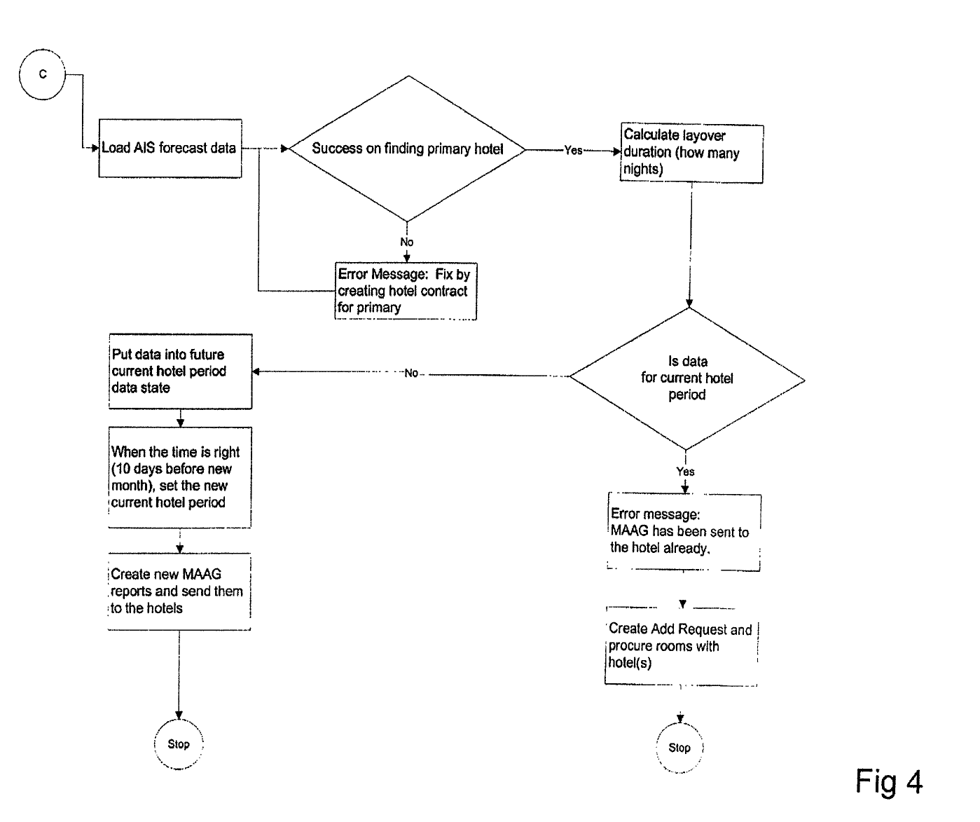

Forecast. FIG. 4 illustrates the forecast process. Forecast data from the AIS is received by the LMS. The LMS maintains a designated primary hotel and list of alternate hotels for each station and airline. These hotels may be further broken down by hotel type, that is, which hotels pilots may use and which hotels flight attendants may use as specified in union contracts. As each layover is received, the LMS uses the layover's date and airline rules to select a primary hotel for each crew member. If the primary hotel declines to confirm any layover requests, which are sent to the hotel in bulk form in the MAAG forecast report, then layover requests are made to alternate hotels in succession until the request is filled. The LMS searches its records to find a hotel on the approved list for each airline. If a hotel is not found, the LMS alerts the user by sending an error message, identifying the need to create a hotel contract for the desiring airline.

Upon selection of a hotel, the LMS calculates the duration of the layover, typically how many nights are needed in the hotel, and how much the hotel will charge the airline for a given layover. Each hotel has a contract which provides the rules for calculating how many nights the hotel will charge for a layover. For example, one set of rules may require that the airline pay for one room each time a room is held by a crew member for any portion of each 24 hour period, regardless of whether the room was full for the whole 24 hour period. Another rule set may require that the airline pay for one room if the crew member checks in before a certain check-in time and departs before a certain check-out time, regardless of how many hours the crew member is there. Contract rules, flight arrival and departure times determine how many nights the hotel will charge for the layover.

Once the layover length is determined, the forecast data including the number of rooms needed per hotel per night for the Current Hotel Period is sent to the hotel. Layovers outside the Current Hotel Period are held in the database in a future current hotel period state. If the layover is not for the Current Hotel Period, no special inventory management is performed, but a current picture of the airline's flight schedule is maintained until the layover falls into the Current Hotel Period. The forecast data will be provided in a MAAG report to the hotel prior to the next Current Hotel Period, preferably giving a lead time of about ten days before the new month.

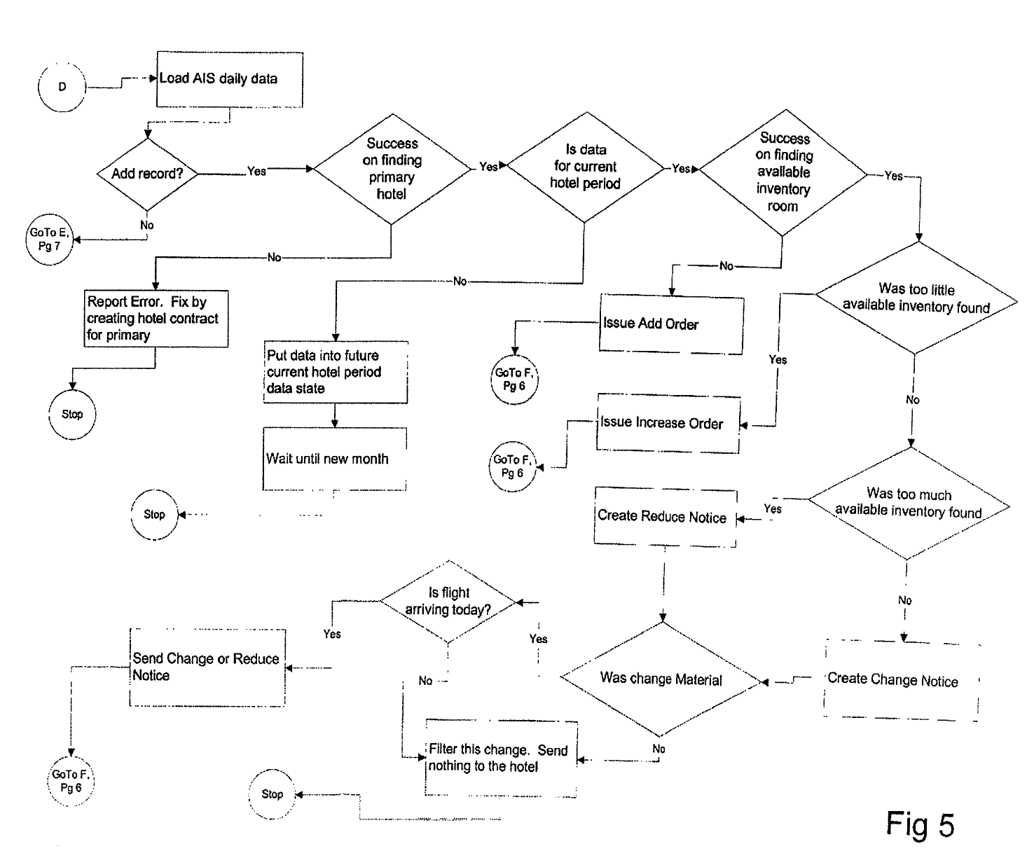

Process updates. After receiving the forecast batch data, the AIS receives update batches sent periodically by the airlines. The AIS forwards the current data to the LMS, updating the LMS typically every fifteen minutes. Updates from the AIS come in two primary types: ADD requests and DROP requests, described in more detail below. FIGS. 5, 6 and 7 illustrate the update process. ADDS and DROPS are provided to the hotel only if they are for the Current Hotel Period.

See FIG. 5. As in the forecast process above, as each layover is received the LMS uses the layover's date and airline rules to select a primary hotel for each crew member. If the update is for the Current Hotel Period it is processed. If the update is not for the Current Hotel Period, it is held until it does fall into a Current Hotel Period. No processing is performed, with the exception of keeping the airline's flight schedule synchronized. This data will be sent to the hotels when the next hotel MAAG report is cut.

An ADD request will attempt to utilize a room that the airline already had in its inventory, that is, already had reserved for crew members and had been confirmed by the hotel. For an ADD request, the database is queried seeking inventory to accommodate the ADD. If a forecast had been sent and no DROPS occurred, no inventory should be available. If inventory is available, however, the hotel is notified with an INCREASE order to fill the room utilizing the new information. INCREASE orders are always sent to the hotel. If too much inventory is available, a REDUCE notice may be sent, if the change is for the day the new data is received. Similar to the INCREASE order, a REDUCE notice is sent to the hotel on the day the change is effective and thereby modifies the daily crew report used by the hotel. Updates for subsequent days are made internally to the LMS database and are not sent to the hotels.

As layover requests are received by the LMS, if an ADD or an INCREASE is received, the difference between when the flight will arrive and the current time is measured. Sorting all flight arrivals on the same time period, preferably Greenwich Mean Time (GMT), the LMS determines which flight will arrive next, independent of which airline and hotel are associated with the layover. After sorting, the record on the top of the queue is closest to arrival, so it is worked first.

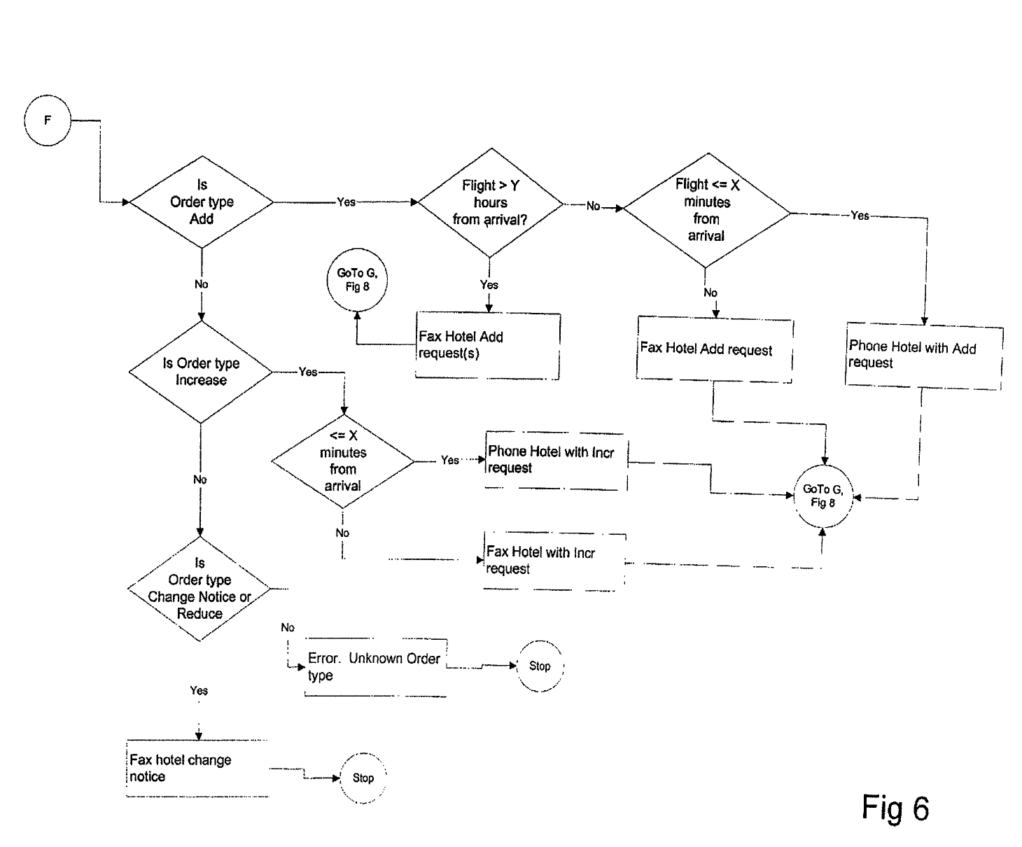

Hotel communication. See FIG. 6. Because the data processed by the LMS is current data pertaining to lodging which is to actually occur within a relatively short time frame, it is important to rapidly communicate with the hotel when additional rooms will be needed. Various methods can be used such as fax, email, system to system interface, or other. The following examples illustrate the preferred methods of contact.

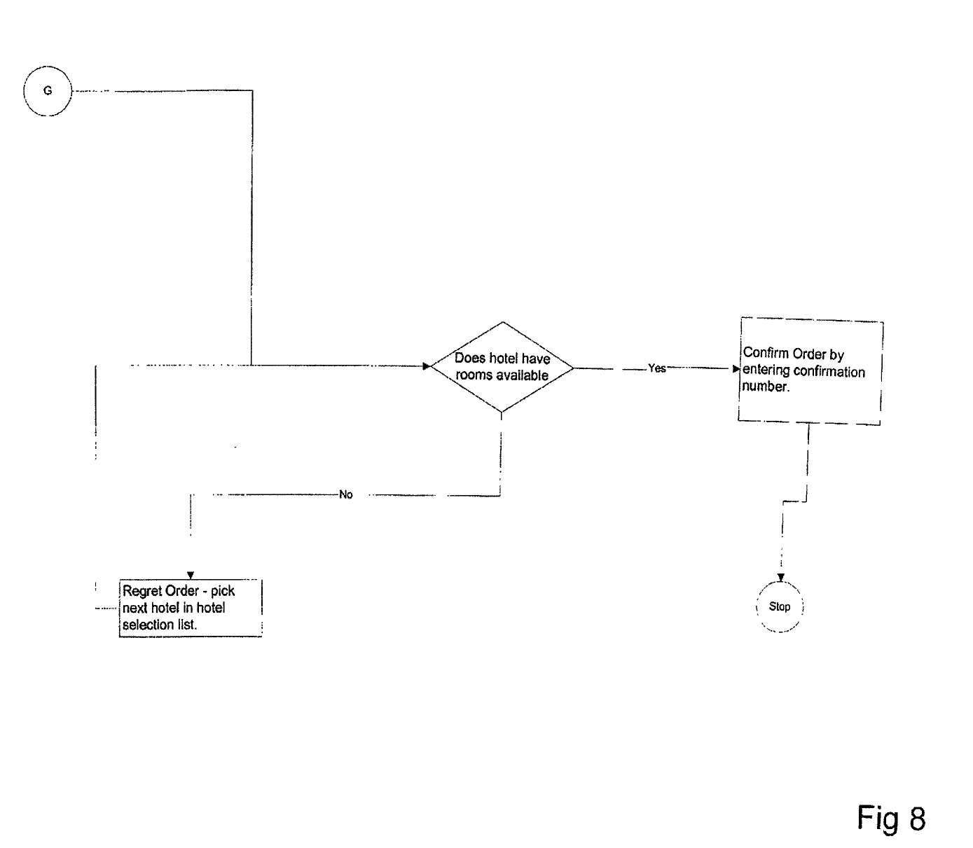

The time periods X and Y for communicating with the hotels are determined by each hotel's unique contract with each airline and may differ for each airline or hotel. If an ADD request is made and the flight is more than Y hours from arrival, the hotel is notified by fax of the request. For convenience, multiple ADD requests are grouped together and sent to the hotel in a single fax report at a specified time. If rooms are available for crew members, the hotel confirms the changes, preferably by return fax. If no rooms are available, the next hotel on the list of approved hotels is queried until a room is found. See FIG. 8.

If an ADD request is made and the flight is less than Y hours from arrival but more than X minutes away, the hotel is notified immediately by fax of the request. If an ADD request is made and the flight is less than X minutes away, the hotel is notified immediately by phone of the request.

If an INCREASE request is made and the flight is more than X minutes from arrival, the hotel is notified immediately by fax of the request. If an INCREASE request is made and the flight is less than X minutes away, the hotel is notified immediately by phone of the request. If a REDUCE request is made, the hotel may be notified by fax of the request if the change is for the current day. Typically airlines procedures do not make cancellations in inventory rooms because the room might be needed for crew from another flight. If cancellations are made, the decrease is made at or near the date of the layover when the likelihood of subsequent changes is less.

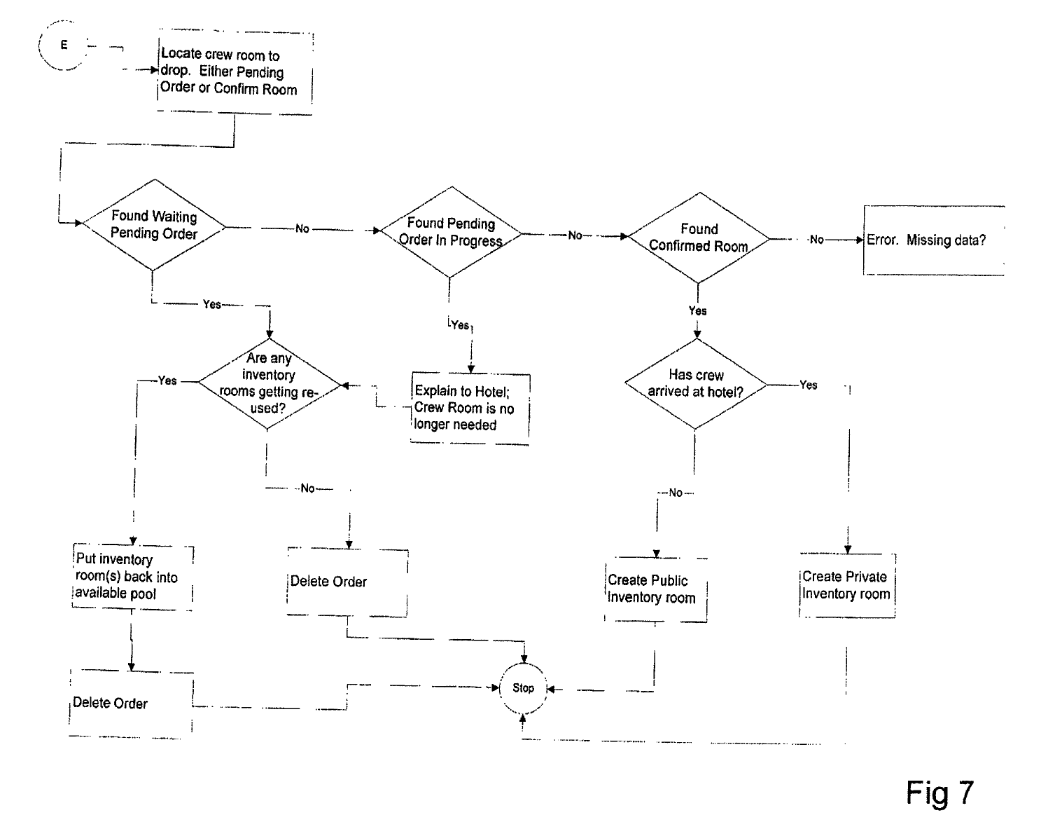

Inventory creation. See FIG. 7. For a DROP request, the record for the crew member is located in the database. If the reservation for a crew member's room is pending and has not yet been confirmed by the hotel and no inventory exists, the ADD and the DROP cancel each other out and the pending reservation request is deleted. If the reservation has not yet been confirmed but is in progress, when the hotel attempts to confirm it, the hotel is notified that a crew member will not need the room. The reservation is stopped short of confirmation and will be deleted. If a reservation for a crew member's room has been confirmed by the hotel, that is, the reservation has matured into inventory and now is being DROPPED, then private inventory is created and the room is held for the specific crew member. If an INCREASE is DROPPED, no change is made to the level of inventory. Private inventory rooms are created if a layover DROP is received after the flight has landed (local time at the hotel) and the crew member is assumed to be in the hotel already. If not, public inventory is created and the room is held for any crew member who may need it. Public inventory rooms are created if a layover drop is receive in advance of the flight landing (local time at the hotel), and it is considered public to be consumed by any crew member.

Sometimes the available inventory will not meet the needs of all crew members arriving. In that case, some crew members will need to be moved to a different hotel. The rules governing the order of selection when pairing or matching the need vs. the pool include the crew member identification and the arriving flight number. An attempt is made to make the entire layover in one hotel, instead of moving crew members after one or two nights to a different hotel.

Change notification. Change notices consist of flight scheduling alterations, regardless of how small or how often. If a schedule change results in a time difference that either increases or reduces the number of days required at a hotel, it is an INCREASE request or a REDUCE request, respectively. Under the philosophy that less is better, the method herein uses filtering and timing logic to diminish the noise that change notices generate. Multiple dimensions are needed to describe the filtering and timing logic including which hotel, whether the change is material, whether the change is for the current period, and whether the change is emergent.

The materiality of a change is important for determining whether the changes will be passed on the hotel, keeping in mind it is desirable to notify the hotel of as few changes as possible. Materality is determined by a number of factors which differ between primary hotels and alternate hotels. In the preferred embodiment, TABLE 3 indicates the factors to be considered for materiality and the outcomes for primary and alternate hotels.

TABLE 3
Materiality of Changes for Primary and Alternate Hotels

| | | Material |
|---|---|---|
| | Material | to |
| | to Primary | Alternate |
| Change Type | Hotels? | Hotel? |
| Change in arrival flight number | Yes | No |
| Arrival time changes >= X min. | Yes | Yes |
| Arrival station (airport) changes | Yes | No |
| Crew member name changes | Yes | Yes |
| Departure flight number changes | No | No |
| Departure time changes | No | No |
| Departure station (airport) changes | No | No |
| Arrival time change < X | No | No |

For each hotel, a scheduled task searches the LMS database once a day for crew members staying in hotels for the coming day. This scheduled task produces a daily crew report displaying for each hotels a list of names and flight details for all crew members and any available inventory rooms being held for an airline until such time they might be canceled. Once the daily crew reports have been issued, the change notices for the same period will no longer be quietly filtered, and the hotels will be notified of any material changes for the date on the daily crew report.

For each hotel, a scheduled task searches the LMS database once a day, using airline-hotel business rules for room cancel candidates. Once identified, the customer service group can act on them, confirming the cancels with the hotels. Rules used to cancel rooms include; hotel cancel deadline time, hotel occupancy tax considerations, status of the station—sold out city, and others. The means to alert the customer service group of these cancel candidates include a printed report per hotel, and cancel orders appearing in a service center work queue.

Reporting. FGI. 9. As each period closes, the LMS has an accounting of all room activity in its tables. The system is able to quickly provide the necessary reconciliation reporting to enable accurate and rapid payment of the requested services. Preferably end-of-month reports are generated. These reports include the hotel reconciliation report and the airline invoice/hotel rollup combination report. The hotel reconciliation report specifies the number of rooms purchased for the month, and it itemizes varying prices as recorded during the month. The airline invoice/hotel rollup combination report specifies a summary section itemizing for all hotels the number of forecasted rooms, added rooms, and cancelled rooms, netting to a total number of rooms. A detail section provides the same items plus the room tax amounts, but for each hotel individually.

Finally, exception processing occurs on layover requests to address situations where the LMS does not have a station setup or does not have a primary hotel assigned to a station for an airline. As exceptions occur, alerts are raised to enable a customer service staff to act on the event and remedy the problem.

Having thus described the invention, it will be apparent to those of skill in the art that various modifications can be made within the scope of the invention. For example, the processed described herein can be implemented on a single computer network for a single airline or multiple airlines. Alternately, the system can be implemented in a client/server or Internet environment. In addition to the airline industry, this layover management system can be used for rail, trucking, third-party service providers, and other travel industries. The model can be applied not only to hotel stays, but to catering, ground support, car rentals, etc.

We claim:

1. An automated system for managing layovers comprising:
a) receiving initial travel schedule information;
b) forecasting lodging requirements from the travel schedule information;
c) receiving additional travel schedule information;
d) comparing the initial travel schedule information to the additional travel schedule information;
e) updating the lodging requirements with.

2. An automated system for managing crew member layovers comprising:
a) receiving initial travel schedule information;
b) forecasting layover requirements from the travel schedule information;
c) reserving the forecasted lodging requirements;
d) receiving additional travel schedule information;
e) comparing the initial travel schedule information to the additional travel schedule information;
f) determining whether each difference between the initial and additional travel schedule data is material;
g) updating the lodging requirements with the material differences.

3. An automated system for managing crew member layovers over a computer network comprising:
a) receiving initial flight schedule information from at least one airline;
b) processing the flight schedule information with a first set of rules to determine layover requirements including the duration of a layover and the number of hotel rooms required for the layover;
c) processing the flight schedule information with a second set of airline rules which include the hotel at which the layover can occur;
d) procuring a number of hotel rooms according to the results of step (c);
e) receiving subsequent flight schedule information from at least one airline;
f) comparing the initial flight schedule information to the subsequent flight schedule information;
f) determining whether each difference between the initial and subsequent flight schedule data is material;
g) updating the layover requirements with the material differences.

4. An automated system for managing crew member layovers over a computer network comprising:
a) receiving initial flight schedule information from at least one airline;
b) storing the flight schedule information in a storage medium;
c) processing the flight schedule information in a first subsystem with a first set of rules to determine general layover requirements including at least the duration of a layover;
d) transmitting the layover requirements to a second subsystem;
e) processing the flight schedule information with a second set of rules to determine detailed layover requirements including the number of hotel rooms required for the layover;
f) procuring a number of hotel rooms according to the results of step (e);
g) receiving subsequent flight schedule information from at least one airline;
h) comparing the initial flight schedule information to the subsequent flight schedule information;
i) determining whether each difference between the initial and subsequent flight schedule data is material according to pre-determined criteria;
j) updating the layover requirements with material changes.

5. An automated system for managing crew member layovers over a computer network comprising:
a) receiving initial flight schedule data from at least one airline;
b) replicating and storing the flight schedule data in an electronic storage medium accessible by the computer network;
c) dividing the initial flight schedule data into a plurality of records, each record containing a flight date;
d) using the flight date, determining whether each record falls within a moving, predetermined time period containing current records;
e) storing records whose flight dates fall outside the first predetermined time period until the flight dates fall within the moving predetermined time period;
f) processing records that fall within the current predetermined time period in a first subsystem with a first set of rules to determine general layover requirements including at least the duration of a layover and number of hotel rooms required and prepare a forecast;
g) transmitting the layover requirements for the current predetermined time period to a second subsystem;
h) processing the layover requirements for the current predetermined time period with a second set rules to determine detailed layover requirements including at which hotel the layover can occur;
i) at no later than a lead time, publishing to at least one hotel the forecast of the flight schedule data and layover requirements for the current predetermined time period;
j) procuring a number of hotel rooms according to the results of step (h);
k) receiving subsequent flight schedule information from at least one airline;
l) comparing the initial flight schedule information to the subsequent flight schedule information;
m) determining whether each difference between the initial and subsequent flight schedule data is material according to pre-determined criteria;
n) updating the layover requirements with material changes;
o) notifying each hotel of material changes in layover requirements.

6. The system according to claim 5 further comprising the step of, when the flight dates of records fall within the moving predetermined time period that has become the current predetermined time period, processing those records according to steps (f) through (o).

7. The system according to claim 5 further comprising the steps of:
a) after the current pre-determined time period, calculating the number of hotel rooms utilized by the crew members for at least one airline for the current pre-determined time period;
b) reporting the number of hotel rooms to the airline and each hotel.

8. The system according to claim 5 wherein detailed layover requirements further comprises at least one crew member name.

9. The system according to claim 5 wherein notifying each hotel of material changes in layover requirements further comprises the steps of:
a) if an ADD request is made and the flight is more than a predetermined amount of time from arrival, notifying the hotel by fax within a pre-determined time;
b) if an ADD request is made and the flight is less than the predetermined amount of time from arrival, notifying the hotel by fax immediately;
c) if an INCREASE request is made and the flight is to arrive shortly, notifying the hotel immediately by telephone.

10. The system according to claim 5 in which the second set of rules includes a rule which determines whether there is a tax advantage to procuring a number of hotel rooms different than that number determined according to the results of step (h).
